(19) United States
(12) Patent Application Publication
(10) Pub. No.: US 2024/0156112 A1
(43) Pub. Date: May 16, 2024

(54) METHOD FOR MAKING A SELF-SUPPORTING FILLED FOOD PRODUCT, BAKING MOLD FOR PERFORMING THE METHOD AND SELF-SUPPORTING FILLED FOOD PRODUCT PREPARED ACCORDING TO THE METHOD

(71) Applicant: SNACK ON STICK, Schoten (BE)

(72) Inventor: Alex HELSEN, Schoten (BE)

(21) Appl. No.: 18/282,651

(22) PCT Filed: Mar. 18, 2022
(86) PCT No.: PCT/IB22/52488

§ 371 Date: Sep. 18, 2023

(30) Foreign Application Priority Data
Mar. 19, 2021 (BE) 2021/5207

(51) Int. Cl. A21D 13/31; A47J 37/06

(52) U.S. Cl. CPC A21D 13/31; A47J 37/0611

(57) ABSTRACT

This disclosure provides a method for making a self-supporting filled food product, wherein at least one food item is wrapped in a layer of dough, after which the layer of dough is cooked so that the layer of dough gains a firmness such that the self-supporting filled food product is obtained in which a first dough portion of the layer of dough substantially fully covers the at least one food item, wherein the layer of dough is shaped in such a way before cooking that after cooking, a second dough portion of the layer of dough extends from the first dough portion away from the at least one food item so as to form a handle for holding the cooked filled food product.

### TECHNICAL FIELD

The present invention relates to a method for making a self-supporting filled food product.

The present invention also relates to a baking mold for performing the method, as well as a self-supporting filled food product prepared according to the method.

### BACKGROUND ART

WO2013050866A1 describes a method in which at least one food item, for example tomato and mozzarella cheese, is wrapped in a layer of pizza dough. The layer of pizza dough is then baked in a baking mold. Through baking, the layer of dough gains a firmness such that a self-supporting filled food product is obtained, a filled pizza in which a dough portion of the layer of dough almost fully covers the food items. In order to facilitate holding the filled pizza thus obtained, a wooden handle is provided. To this end, the handle, together with the food items, is partially enveloped by the layer of dough so that after baking the dough, part of the handle is contained in the layer of set dough, and another part of the handle protrudes out of the filled pizza so as to be held when in use.

Obtaining such filled food products always requires a wooden handle to be provided. This wooden handle is usually discarded after eating the filled food product. From the point of view of avoiding waste, it would be more desirable to be able to avoid the wooden handle. However, if the wooden handle were to be simply omitted, the filled food product would be harder to eat. After all, the wooden handle allows the food product to be held with relative ease, for example with a single hand.

### DISCLOSURE OF THE INVENTION

It is an aim of the present invention to provide a self-supporting filled food product that is also relatively easy to hold, but in which a disposable handle is no longer required.

This aim is achieved by means of the invention according to the characteristics of the first claim.

In particular, the present invention relates to a method for making a self-supporting filled food product, wherein at least one food item is wrapped in a layer of dough, after which the layer of dough is cooked so that the layer of dough gains a firmness such that the self-supporting filled food product is obtained in which a first dough portion of the layer of dough substantially fully covers the at least one food item. The layer of dough is shaped in such a way before cooking that after cooking, a second dough portion of the layer of dough extends from the first dough portion away from the at least one food item so as to form a handle for holding the cooked filled food product.

Such a handle avoids the use of a separate wooden handle. As a result, a disposable handle is no longer needed, while the filled food product is still relatively easy to hold. It was furthermore found that the handle can also be eaten after use. Moreover, the useful weight of the self-supporting filled food product is also increased, as the weight of the wooden handle is avoided.

Moreover, it was found that it is harder for such a handle to unintentionally leave the filled food product, for example when the food item has a rather liquid form.

The first and second dough portions are preferably made from a single continuous layer of dough. Herein, as described, the first and second portions are formed from the single continuous layer of dough by cooking. Such first and second dough portions offer the advantage of being firmly anchored to each other so that a further increased firmness is obtained.

Preferably, substantially the entire layer of dough, and more preferably the entire layer of dough, is cooked. In this way, the entire layer of dough becomes more firm, increasing the handleability of the filled food product.

According to embodiments of the present invention, the second dough portion is formed by folding part of the layer of dough back onto itself at least once before cooking. Such folding of the layer of dough creates at least one fold in the layer of cooked dough. Such folds allow the firmness of the handle to be increased. Moreover, such folds allow the handle to be grasped with a reduced contact surface area, in particular when the fold extends substantially perpendicular to the direction in which the handle extends from the first dough portion, so that the risk of burning is further reduced. Furthermore, the folds allow a faster cooling of the second dough portion.

According to embodiments of the present invention, a figurative shape is formed in the first dough portion. This can be achieved by giving part of the layer of dough a different degree of cooking in the figurative shape. The figurative shape is then obtained by causing a coloration in the shape of the figurative shape by a lower of higher degree of cooking of parts of the layer of dough. The figurative shape can also be obtained by depressing the layer of dough during cooking to a lesser or greater extent relative to surrounding areas in the layer of dough, so that an elevation or depression in the cooked layer of dough is obtained relative to surrounding areas in the cooked layer of dough. Furthermore, it is possible to provide the figurative shape in the form of an edible print, for example printed onto the layer of dough using edible ink.

The present invention also relates to a baking mold for performing the method according to the invention. The baking mold comprises a first baking mold part for receiving, shaping and cooking the first dough portion and a second baking mold part for receiving, shaping and cooking the second dough portion. When using such a baking mold, the dough is cooked by baking.

According to preferred embodiments of the present invention, the second baking mold part is provided with at least one ridge. The ridge preferably takes the form of an elongated protrusion. Such a protrusion allows a corresponding ridge to be formed in the dough at the location of the ridge. Such zones give the handle increased firmness. Furthermore, it is possible to for example cook this zone in the dough further along than the surrounding areas in the dough. This zone may then, through the further cooking, gain an increased firmness, allowing the whole of the second dough portion to obtain an increased firmness, allowing the handle to become sturdy.

According to further embodiments of the present invention, such a ridge allows the layer of dough to be folded back onto itself so as to form at least part of the second dough portion after cooking. Such a ridge allows the folding back onto itself of the layer of dough to be carried out more easily, as well as allowing better baking of the fold that was formed in this way.

According to embodiments of the present invention, the ridge extends longitudinally away from the first baking mold part. With such a formed ridge and the corresponding folding of the layer of dough when using het baking mold part, the firmness of the handle increases due to the creation of the aforementioned folds in the layer of dough. Moreover, such folds allow the handle to be grasped with a reduced contact surface area, in particular when the fold extends substantially perpendicular to the direction in which the handle extends from the first dough portion, so that the risk of burning is further reduced. Furthermore, the folds allow a faster cooling of the second dough portion.

According to preferred embodiments, the baking mold is arranged for being in contact along substantially the entire layer of dough. In this way, substantially the entire layer of dough, preferably the entire layer of dough, is cooked, improving the handleability of the filled food product. Moreover, a more homogenous heating of the food product enveloped in the dough is achieved in this way.

According to preferred embodiments, the first baking mold part comprises a figurative baking mold. The figurative baking mold is arranged to for example cause a discoloration in the shape of the figurative baking mold due to a different degree of cooking of parts of the layer of dough. For example, a lower or higher degree of cooking of the layer of dough. The figurative baking mold may also be arranged to depress the layer of dough to a greater or lesser extent relative to surrounding areas of the layer of dough so as to obtain a figurative shape in the layer of dough.

The invention also relates to a self-supporting filled food product prepared according to the present invention, wherein at least one food item is wrapped in a layer of cooked dough, wherein a first dough portion of the layer of cooked dough substantially fully covers the at least one food item. A second dough portion of the layer of cooked dough extends from the first dough portion away from the at least one food item so as to form a handle for holding the cooked filled food product.

According to embodiments of the present invention, the food product is substantially fully enveloped by the layer of cooked dough. Such a configuration allows an increased handleability of the food product.

According to embodiments of the present invention, the first dough portion tapers toward the second dough portion. Such a shape allows the layer of dough to be cooked along substantially its entire surface with relative ease. Moreover, such a shape offers the advantage that a more sturdy connection between the first and second dough portions is obtained when compared to a more abrupt transition, such as for example a step-wise transition from the first dough portion to the second dough portion.

According to embodiments of the present invention, the first dough portion comprises a figurative shape, wherein the shape is for example achieved through a coloration that is in turn obtained through for example a different degree of cooking, for example a lower or higher degree of cooking of the layer of dough. Such a figurative shape, for example a text or figure, can for example increase the attractiveness of the product. The figurative shape may also take the form of a depression and/or an elevation of the layer of dough.

According to embodiments, the second dough portion comprises at least one part of the layer of cooked dough folded back onto itself such a formed layer of dough increases the firmness of the handle as a result of the creation of the aforementioned folds in the layer of dough by folding the layer of dough back onto itself. Moreover, such folds allow the handle to be grasped with a reduced contact surface area, in particular when the fold extends substantially perpendicular to the direction in which the handle extends from the first dough portion, so that the risk of burning is further reduced. Furthermore, the folds allow a faster cooling of the second dough portion. Preferably, the part of the layer of cooked dough that is back folded onto itself is back folded onto itself along a folding line extending longitudinally away from the food item. It was found that such a folding line increases the sturdiness of the handle.

### BRIEF DESCRIPTION OF THE DRAWINGS

The invention will be further elucidated by means of the following description and the appended figures.

FIG. 1 shows a view, in particular a top view, of a food product according to the present invention.

FIG. 2 shows a further view, in particular a side view, of the food product of FIG. 1.

FIG. 3 shows an overview, in particular a top view, of a baking mold according to the present invention.

FIG. 4 shows an overview of a baking appliance provided with the baking mold of FIG. 3 in a closed state.

FIG. 5 shows an overview of the baking appliance of FIG. 4 provided with the baking mold of FIG. 3 in an open state.

### MODES FOR CARRYING OUT THE INVENTION

The present invention will hereafter be described with respect to particular embodiments and with reference to certain drawings, but the invention is not limited thereto and is defined only by the claims. The drawings shown here are merely schematic depictions and are non-limiting. In the drawings, the dimensions of certain parts may be exaggerated, meaning that the parts in question are not drawn to scale, for illustrative purposes only. The dimensions and the relative dimensions do not necessarily correspond to the actual reductions to practice of the invention.

Furthermore, terms such as “first”, “second”, “third” and the like are used in the description and in the claims for distinguishing between similar elements, and not necessarily for describing a sequential or chronological order. The terms in question are interchangeable under the appropriate circumstances and the embodiments of the invention can operate in other sequences than described or illustrated here.

Moreover, terms such as “top”, “bottom”, “over”, “under” and the like are used in the description and the claims for descriptive purposes. The terms so used are interchangeable under the appropriate circumstances, and the embodiments of the invention can operate in other orientations than those described or illustrated herein.

The term “comprising” and derivative terms, as used in the claims, should not be interpreted as being restricted to the means listed respectively thereafter; the term does not exclude other elements or steps. It should be interpreted as specifying the stated features, integers, steps or components as referred to, without, however, precluding the presence or addition of one or more additional features, integers, steps or components, or groups thereof. Thus, the scope of an expression such as “a device comprising means A and B” is not limited to devices consisting only of components A and B. What is meant, in contrast, is that with respect to the present invention, the only relevant components of the device are A and B.

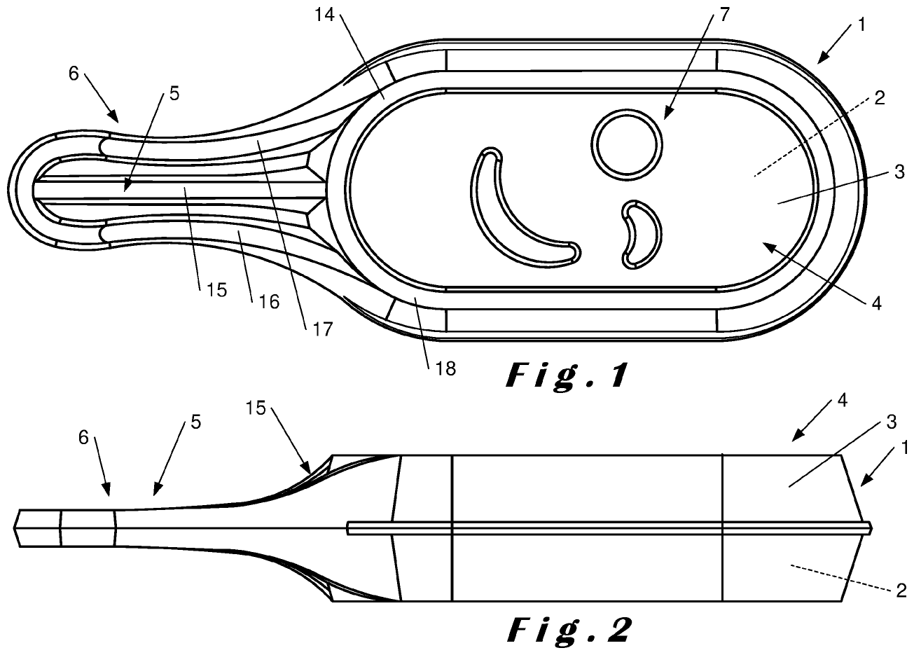

FIGS. 1 and 2 show an embodiment of a food product according to the present invention. In particular, it is a self-supporting filled food product 1. Self-supporting is for example and preferably meant to signify that the food product can be held, preferably in substantially all directions relative to gravity, and still essentially retains its shape, and this for a relatively long time, for example half an hour or less. In the food product, at least one food item 2 is wrapped in a layer of cooked dough 3. The food item may be any food item of choice, such as for example a savory food item 2, for example a pizza filling, such as for example a composition comprising for example tomato and mozzarella cheese, chicken ragout (vol-au-vent), chicken curry, a cheese composition, for example based on leek, cheese and ham, etc. However, this is not essential to the present invention and the food item may also be sweet, such as for example a filling based on chocolate, possibly combined with fruit, such as for example banana, raisins, dates, etc.

In particular, a first dough portion 4 of the layer of cooked dough 3 covers the at least one food item 2 in substantially its entirety. A second dough portion 5 of the layer of cooked dough 3 extends from the first dough portion 4 away from the at least one food item 2 so as to form a handle 6 for holding the cooked filled food product 1.

Preferably, the first dough portion 4 is in the form of a container, such as for example a container having ellipsoidal top and bottom surfaces. However, other shapes of the container are also possible and may be determined by the person skilled in the art. The distance between the top and bottom surfaces, the thickness, is for example determined as a function of for example the desired degree of cooking of the core of the food item 2 and/or the dimensions of a typical human mouth.

The handle 6 is preferably substantially flat and preferably about 2-6 cm long, as it was found that such a shape fits well in a user's hand. The dimensions and shape of the handle 6 are also determined by for example the weight of the food item contained in the first dough portion 4 and the first dough portion itself 4.

The food product 1 of FIGS. 1 and 2 is essentially entirely, and even entirely, enveloped by the layer of cooked dough 3, improving the handleability of the food product. However, this is not essential to the present invention, it is for example possible for part of the food item 2 not to be enveloped by the layer of cooked dough 3 and to remain visible.

FIG. 2 further shows that the first dough portion 4 tapers toward the second dough portion 5. However, this is not essential to the present invention, the transition from the first 4 to the second dough portion may also be step-wise.

Furthermore, FIG. 1 shows that the first dough portion 4 comprises a figurative shape 7. The figurative shape 7 may be obtained by means of for example a coloration and/or a depression and/or an elevation in the layer of cooked dough 3. The coloration is for example caused by a different degree of cooking, for example a lower or higher degree of cooking of the layer of dough 3. The figurative shape 7 may have any desired shape as determined by the person skilled in the art.

Preferably, the food product 1 is prepared by filling a layer of not yet fully cooked dough 3 with a food item 2, and then further cooking the layer of dough 3 so that it develops a certain firmness and becomes self-supporting. After this, the first dough portion 4 of the layer of dough 3 covers the food item 2 essentially entirely as described, and the second dough portion 5 of the layer of dough 3 extends from the first dough portion 4 away from the at least one food item 2, thus forming the handle 6. The first and second dough portions are preferably made from a single continuous layer of still uncooked dough 3. Preferably, essentially the entire layer of dough 3 is cooked.

The dough used in the layer of dough 3 is preferably pizza dough. However, other types of dough are also possible and are determined as a function of, for example, the application and/or the filling. The dough may for example also be vegetable based, such as for example cauliflower based.

During cooking, the figurative shape is preferably provided in the layer of dough 3, for example in the first dough portion 4 or the second dough portion 5.

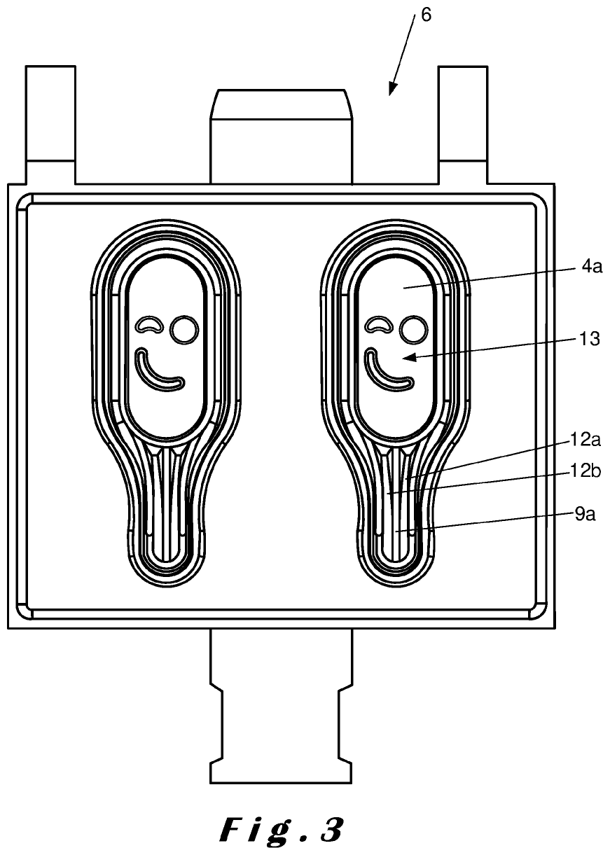

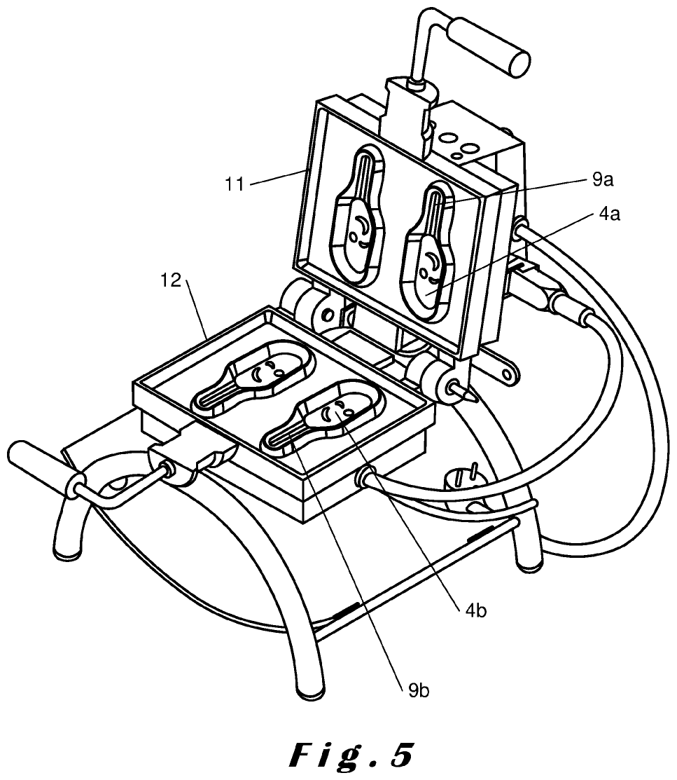

The method is preferably carried out in a baking mold 11 provided for this purpose, of which an embodiment is shown in FIG. 3. The baking mold 11 comprises a first baking mold part 9 for receiving, shaping and cooking the first dough portion 4 and a second baking mold part 9 for receiving, shaping and cooking the second dough portion 5. A second baking mold 12, shown in FIG. 5, allows two opposite sides of the layer of dough 3 to be cooked.

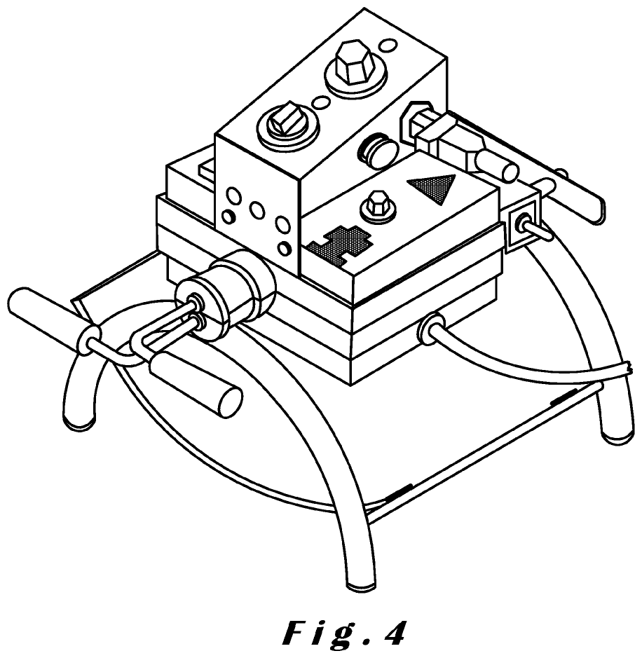

As shown in FIG. 5, the first and the second baking mold part 4, 9 are provided in two respective parts 4a, 4b and 9a, 9b, as is typical in for example a waffle iron. The closed state is shown in FIG. 4. These parts are formed into two baking molds 11 and 12.

FIG. 5 further shows that part of the first baking mold part 4 tapers toward the second baking mold part 5 and is arranged for making the first dough portion 4 taper toward the second dough portion 5 after cooking.

FIG. 3 shows that the second baking mold part 9 is provided with at least one ridge 12, in particular 12a and 12b. The ridge 12 extends longitudinally away from the first baking mold part 9. FIG. 2 shows that two such ridges 12a and 12b are provided. The number of ridges 12 may be determined by the person skilled in the art as a function of for example the nature of the dough and the required sturdiness. More preferably, the at least one ridge 12 is also provided along the part of the first baking mold part 9 that tapers toward the second baking mold part 9, to for example further increase the sturdiness of the dough in that location.

FIG. 1 shows that corresponding to the ridges 12a and 12b in the baking molds 11 and 12, corresponding rib-shaped elevations are formed in the layer of dough 3, which are indicated with 15, 16 and 17.

FIG. 1 also shows that an elongated elevation 18 is preferably provided along a peripheral edge of the first dough portion 4, more preferably two such elevations on opposite sides of the first dough portion 4. It was found that such an elevation further increases the sturdiness of the food product.

The baking molds 11 and 12, shown in FIG. 5, are arranged for being in contact along substantially the entire layer of dough 3.

FIG. 3 shows that the first baking mold part 9 comprises a figurative baking mold 13. This baking mold part 9 is for example arranged so that it presses into in the layer of dough 3 during cooking of the layer of dough 3 and thus creates a depressed shape in the layer of dough 3, and/or causes increased or increased cooking, and thus respectively a darker or lighter color, of the layer of dough at the figurative baking mold 13, causing the figurative shape 7 to become visible. Furthermore, it is possible to arrange the figurative baking mold 13 farther from the layer of dough so that an elevation in the layer of dough 3 is obtained and/or an increased or diminished cooking, and thus respectively a darker or lighter color, is obtained when compared to the surrounding layer of dough 3 so as to make the figurative shape 7 visible.

Although certain aspects of the present invention have been described in reference to specific embodiments, it should be understood that these aspects may be implemented in other forms within the scope as determined by the claims.

1. A method for making a self-supporting filled food product, wherein at least one food item is wrapped in a layer of dough, after which the layer of dough is cooked so that the layer of dough gains a firmness such that the self-supporting filled food product is obtained in which a first dough portion of the layer of dough substantially fully covers the at least one food item, wherein the layer of dough is shaped in such a way before cooking that after cooking, a second dough portion of the layer of dough extends from the first dough portion away from the at least one food item so as to form a handle for holding the self-supporting filled food product.

2. The method according to claim 1, wherein the first and second dough portions are made from a single continuous layer of dough.

3. The method according to claim 1, wherein substantially an entirety of the layer of dough is cooked.

4. The method according to claim 1, wherein a figurative shape is applied to the first dough portion.

5. A baking mold for performing the method according to claim 1, wherein the baking mold comprises a first baking mold part for receiving, shaping and cooking the first dough portion and a second baking mold part for receiving, shaping and cooking the second dough portion.

6. The baking mold according to claim 5, wherein the second baking mold part is provided with at least one ridge.

7. The baking mold according to claim 6, wherein the ridge extends longitudinally away from the first baking mold part.

8. The baking mold according to claim 1, wherein the baking mold is arranged for being in contact along substantially an entirety of the layer of dough.

9. The baking mold according to claim 7, wherein the first baking mold part comprises a figurative baking mold.

10. A self-supporting filled food product made according to claim 1, wherein at least one food item is wrapped in a layer of cooked dough, wherein a first dough portion of the layer of cooked dough substantially fully covers the at least one food item, wherein a second dough portion of the layer of cooked dough extends from the first dough portion away from the at least one food item so as to form a handle for holding the self-supporting filled food product.

11. The self-supporting filled food product according to claim 10 wherein the self-supporting filled food product is substantially fully enveloped by the layer of cooked dough.

12. The self-supporting filled food product according to claim 11, wherein the first dough portion tapers toward the second dough portion.

13. The self-supporting filled food product according to claim 12, wherein the first dough portion comprises a figurative shape.
